(19) United States
(12) Patent Application Publication
(10) Pub. No.: US 2010/0131870 A1
(43) Pub. Date: May 27, 2010

(54) WEBPAGE HISTORY HANDLING METHOD AND APPARATUS FOR MOBILE TERMINAL

(75) Inventor: Sang Min PARK, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/622,616

(22) Filed: Nov. 20, 2009

(30) Foreign Application Priority Data
Nov. 21, 2008 (KR) 10-2008-0116439

(51) Int. Cl. G06F 3/01; G06F 3/048

(52) U.S. Cl. 715/760; 715/810

(57) ABSTRACT

A webpage history handling method and apparatus for a mobile terminal includes generating a list related to a first webpage, and when a second webpage is generated or received, the level of association between the second webpage and first webpage is examined. The second webpage is added to the list related to the first webpage or a new list related to the second webpage is created, according to the association level. In addition, when a webpage is displayed, a sub-list may be created to include those sections of the webpage attracting user's attention and is attached to the webpage.

### CLAIM OF PRIORITY

This application claims priority from an application entitled “WEBPAGE HISTORY HANDLING METHOD AND APPARATUS FOR MOBILE TERMINAL” filed in the Korean Intellectual Property Office on Nov. 21, 2008 and assigned Serial No. 10-2008-0116439, the contents of which are incorporated herein by reference in its entirety.

### BACKGROUND OF THE INVENTION

1. Field of the Invention

The present invention relates generally to a mobile terminal and, more particularly, to a webpage history handling method and apparatus for a mobile terminal that facilitates viewing of visited webpages.

2. Description of the Related Art

Recently, mobile terminals have become widespread in use by most segments of the population. In particular, mobile terminals enabling voice calls have become so popular that most individuals now carry one. In addition to call-related functions, a mobile terminal may have various functions related to, for example, an audio file playback through an MP3 player, an image capture function through a digital camera module, and mobile or arcade gaming, just to name a few functions.

A mobile terminal may have the capability to access a web server through a mobile communication system or specific communication module, and provide a web browsing service enabling the user to browse webpages from the web server. However, as the screen size of a mobile terminal is significantly smaller than that of a computer monitor, it may be difficult for the mobile terminal to display webpages designed for computer monitors having a full-screen size.

### SUMMARY OF THE INVENTION

The present invention provides a webpage history handling method and apparatus for a mobile terminal that can effectively manage webpages generated during web browsing utilizing history lists to enable the user to browse webpages in an easy and convenient manner.

In accordance with an exemplary embodiment of the present invention, there is provided a webpage history handling method for a mobile terminal that can include: receiving a first webpage from a connected web server; creating a list related to the first webpage; receiving a second webpage; examining a level of association between the second webpage and the first webpage; and performing webpage grouping by adding, when the association level is greater than or equal to a preset value, the second webpage to the list related to the first webpage, and by creating, when the association level is lower than the preset value, a list related to the second webpage.

In accordance with another exemplary embodiment of the present invention, there is provided a webpage history handling apparatus for a mobile terminal, that can include: a radio frequency unit for connecting to a web server and receiving webpage data from the web server; a history management module for creating a list related to an initially received webpage, examining, when the current webpage is generated, the level of association between the current webpage and a previous webpage, adding, when the association level is greater than or equal to a preset value, the current webpage to the list related to the previous webpage, and creating, when the association level is lower than the preset value, a list related to the current webpage; and a display unit outputting a webpage and a list of webpages.

According to an exemplary aspect of the present invention, the method and apparatus groups together various webpages received from web servers according to given criteria and manages the grouped webpages by the use of history lists. Hence, the user of a mobile terminal can rapidly navigate previously visited webpages.

### BRIEF DESCRIPTION OF THE DRAWINGS

The features and advantages of the present invention will become more apparent from the following detailed description in conjunction with the accompanying drawings, in which:

FIG. 1 is a block diagram illustrating a mobile terminal according to an exemplary embodiment of the present invention;

FIG. 2 illustrates a storage unit and control unit of the mobile terminal of FIG. 1;

FIG. 3 illustrates an example of a history management module that can be arranged in or coupled with the control unit shown in FIG. 1;

FIG. 4 illustrates exemplary screen representations for lists and sub-lists;

FIG. 5 is a flow chart illustrating an exemplary operational procedure for history list generation according to another exemplary embodiment of the present invention;

FIG. 6 is a flow chart illustrating an exemplary operational procedure for sub-list generation according to another exemplary embodiment of the present invention; and

FIG. 7 is a flow chart illustrating an exemplary operational procedure for history list browsing according to another exemplary embodiment of the present invention.

### DETAILED DESCRIPTION

Hereinafter, exemplary embodiments of the present invention will now be described in detail with reference to the accompanying drawings. The same reference symbols are used throughout the drawings to refer to the same or like parts. Detailed descriptions of well-known functions and structures incorporated herein may be omitted to avoid obscuring appreciation of the subject matter of the present invention by a person of ordinary skill in the art. Particular terms may be defined in order to describe the invention in a best mode. Accordingly, the meaning of specific terms or words used in the specification and the claims should not be limited to the literal or commonly employed sense, but should be construed in accordance with the spirit of the invention as would be understood by a person of ordinary skill in the art. The description of the various exemplary embodiments is to be construed as being provided only for illustrative purposes and does not describe every possible instance of the claimed invention, nor limit the claimed invention to the examples shown and described herein. Therefore, it should be understood that various changes may be made and equivalents may be substituted for elements of the invention.

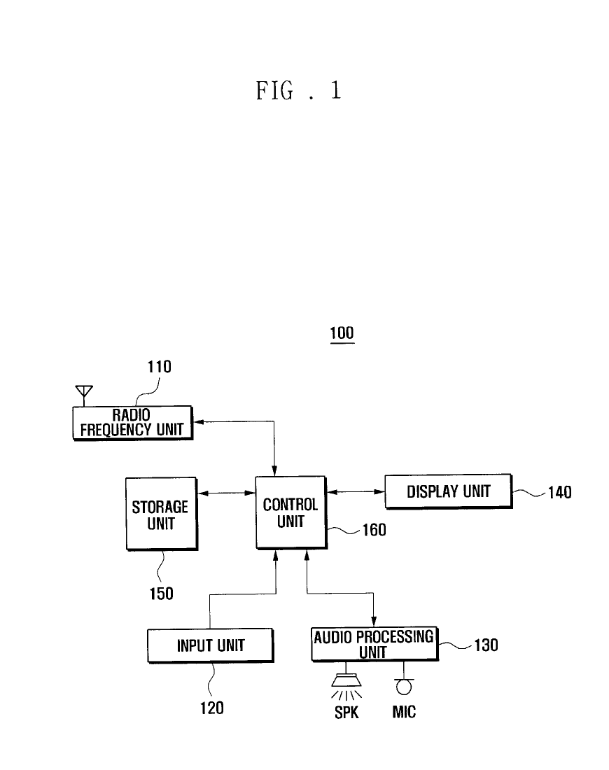

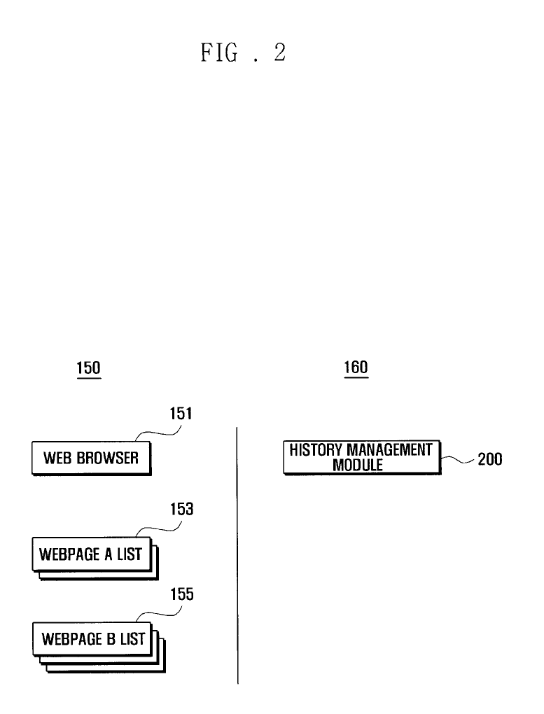

FIG. 1 is a block diagram illustrating a mobile terminal 100 according to an exemplary embodiment of the present invention.

Referring now to the example of FIG. 1, the mobile terminal 100 preferably includes a radio frequency unit 110, input unit 120, audio processing unit 130, display unit 140, storage unit 150, and control unit 160. The mobile terminal 100 may further include, for example, a camera module for capturing images, and a broadcast reception module for receiving broadcast signals.

When receiving webpages after connecting to a web server, the mobile terminal 100 groups the received webpages by preset association level, and stores and manages the grouped webpages utilizing lists. In addition, the mobile terminal 100 can manage specific portions of webpages visited during webpage browsing utilizing sub-lists. The result is that a user can navigate lists of visited webpages in a rapid and convenient manner. A webpage list may include addresses of visited webpages and other pertinent information regarding visited webpages.

Still referring to FIG. 1, the radio frequency unit 110 sends and receives a voice signal related to voice communication and a data signal related to data communication under the control of the control unit 160. For signal transmission and reception, the radio frequency unit 110 may include, for example, a radio frequency transmitter for upconverting the frequency of a signal to be transmitted and for amplifying the signal, and a radio frequency receiver for low-noise for amplifying a received signal and for downconverting the frequency of the received signal. More particularly, in response to an input signal from the input unit 120, the radio frequency unit 110 connects to a web server, and receives webpage data from the web server and forwards the webpage data to the control unit 160. When the mobile terminal 100 connects to a web server via a mobile communication system, the radio frequency unit 110 may act as a mobile communication module. When the mobile terminal 100 directly connects to a web server without use of a mobile communication system, the radio frequency unit 110 may act as a wireless modem such as a Wibro modem.

The input unit 120 preferably includes a plurality of alphanumeric and function keys for inputting alphanumeric information and setting various functions, and generates input signals corresponding to the keys and sends the input signals to the control unit 160. The function keys may include direction, side, and shortcut keys associated with particular functions. Particularly, in response to a user request, the input unit 120 may generate an input signal for activating a web browser stored in the storage unit 150, a direction key signal for viewing a webpage on the display unit 140, an input signal for inputting a search term during display of the webpage, or an input signal for clicking one of various links in the webpage, and send the generated signal to the control unit 160. A person of ordinary skill in the art should understand that the input unit may comprise, for example, a touch screen without physical key buttons.

The audio processing unit 130 reproduces an audio signal from the control unit 160 through a speaker SPK, and sends an audio signal, such as a voice signal, from a microphone MIC to the control unit 160. That is, the audio processing unit 130 converts voice and audio data from the control unit 160 into an audible signal and outputs the audible signal to the speaker SPK, and converts an analog voice signal from the microphone MIC into digital data and sends the digital data to the control unit 160. In particular, when the mobile terminal 100 accesses a web server and receives a webpage, the audio processing unit 130 may output an audio signal provided by the webpage through the speaker SPK, or play back an audio file linked to the webpage in response to a user playback request and output an audio signal of the audio file.

With continued reference to FIG. 1, the display unit 140 displays an activated window in relation to a function of the mobile terminal 100. For example, the display unit 140 may display a boot window, an idle window, a menu window, and a call window. The display unit 140 may include a panel of liquid crystal display (LCD) devices, an LCD controller, and/or any other type of thin film display, and a memory device for storing data. If the panel has a touch screen capability, the display unit 140 can also act as an input means, eliminating the need for a separate input unit 120. The display unit 140 may further include a touch part and may act as a touch screen. In this case, the display unit 140 may display a key map for user settings and terminal manipulation on a part of the screen. The display unit 140 may display various on-screen keys for manipulating the mobile terminal 100, and detect a touch made by the user and recognize an on-screen key mapped to the touch. In particular, the display unit 140 displays webpages received from a web server. In response to an input signal from the input unit 120, the display unit 140 may display a new webpage at least partially on/over a webpage being displayed. That is, during display of webpage A, when the user clicks a link in webpage A, inputs a search term, or generates an input signal to activate a web browser, the display unit 140 may display a corresponding webpage B on top of webpage A so as to hide webpage A. When displaying at least partially overlapped webpages, the display unit 140 may display a multi-tab zone indicating display of multiple webpages.

In addition, the display unit 140 may display one or more lists. Webpages visited by the user are grouped by association level, and the grouped webpages are managed using lists. Webpages in a webpage list have the same association level, and may be listed in a demarcated region of the display unit 140. A webpage list displayable in an assigned demarcated region may contain web address information of webpages and images associated with webpages. The webpage list may further contain, for example, association information related with webpages such as search terms or links.

When the user selects a webpage in a given list, the display unit 140 may display a sub-list associated with the selected webpage. The sub-list is composed of sections of a whole webpage enlarged using a zoom-in feature for more detailed view. More specifically, when the user downloads a webpage from a web server with a mobile terminal supporting full browsing, the whole webpage is displayed on the display unit. However, the webpage may be not clearly viewable owing to screen size limitations, as a mobile terminal typically has a relatively smaller screen as compared to stationary displays. Accordingly, in order to clearly view a particular section of the webpage, the user may issue an enlargement request. The display unit then enlarges the requested section and displays the enlarged section. A sub-list is related to this enlarged section of a webpage. When the user continues to view a particular section of a displayed webpage for longer than or equal to a preset time duration, a sub-list may be provided containing information regarding the viewed section such as coordinates, and a presentation duration. The display unit 140 may also output a sub-list, for example, as slides displayable at regular intervals. Sections constituting a sub-list displayable in the form of slides may have assigned presentation weights, and one section may be displayed longer than another section.

Still referring to the example shown in FIG. 1, the storage unit 150 stores application programs for the functions related to the present invention, and stores application programs and user data for the operation of the radio frequency unit 110. The storage unit 150 may also include a buffer area to temporarily store data received from a web server. More particularly, as shown in FIG. 2, the storage unit 150 in this example stores a web browser 151, a webpage A list 153, and a webpage B list 155.

The web browser 151 is an application program that is used by the mobile terminal 100 to access a web server. The web browser 151 is activated in response to an input signal from the input unit 120, and connects to a web server by the use of a preset address (for example, an IP address or URL) or an address given by the user. The web browser 151 obtains an IP address for the mobile terminal 100 from a base station, and establishes a TCP/IP connection to the web server. The web browser 151 uses an allocated socket to communicate with the web server, and may use one socket for one webpage. The web browser 151 may use multiple sockets for multiple webpages, and activate a socket assigned to the topmost one of webpages being displayed on the display unit 140 and deactivate the remaining sockets.

With continued reference to FIGS. 1 and 2, the webpage A list 153 is created by a history management module 200 of the control unit 160. When a new webpage is output (while the current webpage is output), or when a new webpage is output after the current webpage is deleted, the new webpage may be added as an entry to the webpage A list 153 according to the level of association between the current webpage and the new webpage.

The webpage B list 155 is a list that is created under the control of the control unit 160 when, after creation of the webpage A list 153, the level of association between a new webpage and the webpage A list 153 is less than or equal to a preset value. That is, the webpage A list 153 includes a given webpage as an initial entry at the beginning. In this particular aspect of the invention, whenever a new webpage is created by the user, the level of association between the new webpage and the webpage A list 153 is determined. If the association level is greater than or equal to a preset value, the new webpage is added as a new entry to the webpage A list 153. However, if the association level is less than the preset value (the new webpage is not related to the entries of the webpage A list 153), the new webpage is added as an entry to the webpage B list 155.

In addition, it is preferable that whenever a new webpage is created by the user, the level of association between the new webpage and an existing list should be determined. If the association level is greater than or equal to a preset value, the new webpage is added as a new entry to the existing list, which is stored in the storage unit 150. If the association level is less than the preset value, a new list is created and the new webpage is added as an entry to the new list, which is stored in the storage unit 150.

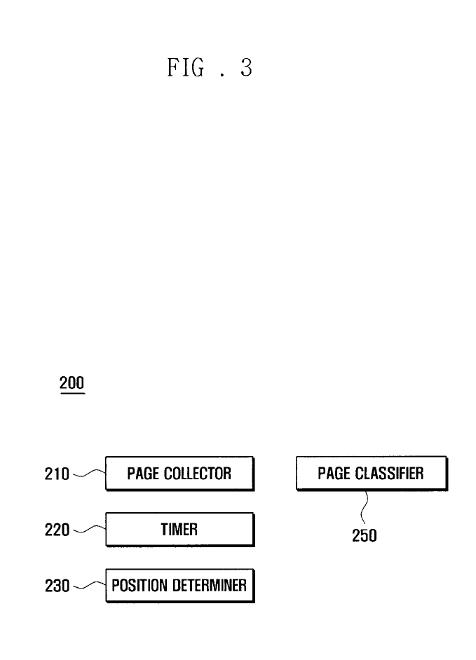

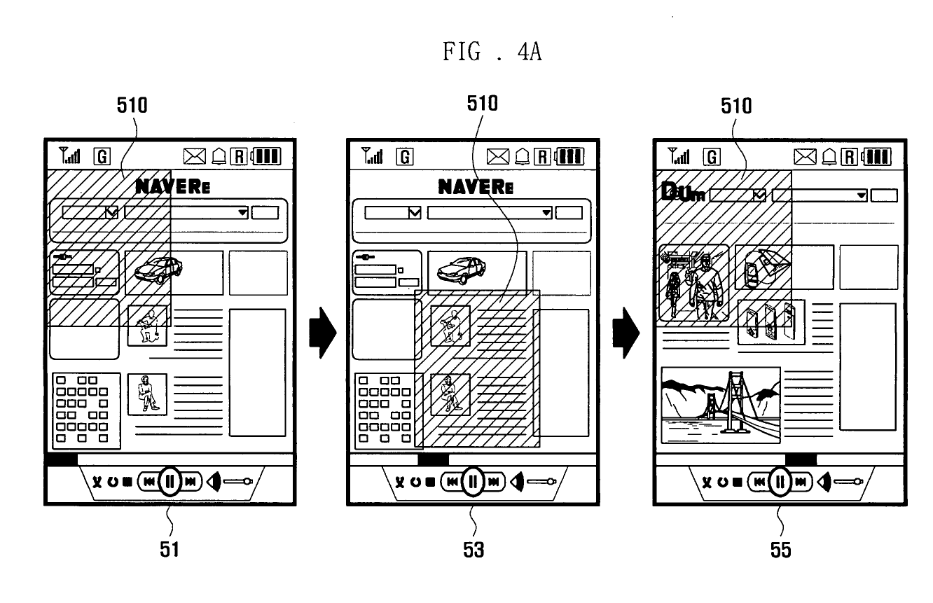

The control unit 160 controls power supplied to the mobile terminal 100, and controls activation of individual components and a signal exchange between the components. In particular, the control unit 160, for example, activates the web browser 151 according to a user request, and groups webpages generated by the web browser 151 utilizing the history management module 200. This function is described in more detail in connection with FIG. 3 hereinbelow.

FIG. 3 illustrates one example of the history management module 200 of the control unit 160.

Referring now to FIG. 3, the history management module 200 in this example may include a page classifier 250, a page collector 210, a timer 220, and a position determiner 230. The history management module 200 creates and manages lists of webpages, and creates and manages a sub-list of a webpage list.

The page classifier 250 creates and manages a list of webpages. That is, when the mobile terminal 100 connects to a web server and receives a webpage, the page classifier 250 creates a webpage list on the basis of the webpage. Thereafter, when a new webpage is received, the page classifier 250 adds the new webpage as an entry to the existing webpage list or creates a new webpage list on the basis of the new webpage according to the level of association between the existing webpage and the new webpage.

Whenever a new webpage is created using a link contained in the current webpage, the page classifier 250 determines whether the level of association between the current webpage and the new webpage is high (as compared with a predetermined level or threshold value). However, when the new webpage is created using a link for advertisement in the current webpage, the page classifier 250 may determine that the level of association between the current webpage and the new webpage is low as compared with the predetermined level or threshold value (i.e. “compares favorably”). When the current webpage is being output in a single webpage search, the page classifier 250 determines that the previous webpage and next webpage viewable using the ‘previous’ button and ‘next’ button are highly associated with the current webpage. Hence, the page classifier 250 may add a new webpage as an entry to the existing webpage list.

When a new webpage is generated by the use of a bookmark, for example, of a web address input to an address box, or of a search term input to a search box, the page classifier 250 may determine that the level of association between the current webpage and the new webpage is low as compared with a predetermined level or threshold value (i.e. “does not compare favorably”), and create a new webpage list on the basis of the new webpage. However, in the case where a new webpage is generated by the use of a search term, when the search term used for the new webpage is similar (i.e. matches a least a portion of certain predetermined criteria) to that used for the current webpage, the page classifier 250 may add the new webpage as an entry to the webpage list containing the current webpage. To achieve this, the page classifier 250 may include a categorization table for search terms, and group webpages into various webpage lists related to, for example, weather, games, security, and sports on the basis of the categorization table. In the case where a new webpage is generated by the use of a bookmark, when the web address used for the new webpage is similar (i.e. matches a least a portion of certain predetermined criteria) to that used for the current webpage, the page classifier 250 may add the new webpage as an entry to the webpage list containing the current webpage. In the case where a new webpage is generated by use of a new address, when the address used for the new webpage is similar (i.e. matches a least a portion of certain predetermined criteria) to that used for the current webpage, the page classifier 250 may add the new webpage as an entry to the webpage list containing the current webpage. It is also possible that the server could assign an initial classification value to web pages in a somewhat similar manner that library systems used to use to categorize books, and the mobile terminal can receive the page and use the classification value as a basis to determined whether or not to set up a new list or keep the page in a current list (A list) based on a comparison of the classification value. Such as system could save computer processing time on the part of the mobile terminals, and could eliminate redundant operations being carried out by the millions of mobile terminals receiving the common webpages, because if the page arrives with a general category classification, the mobile terminal would not have to parse the content of the page, or may only have to do so on an optional basis, or if the classification cannot be determined or is not present on a particular webpage.

As described above, the page classifier 250 may assign association levels to various combinations of webpages, and can regard a new webpage as being associated with the current webpage when the level of association between the new webpage and the current webpage is greater than or equal to a preset value, and maintain the current webpage and new webpage in the same webpage list.

Still referring to FIG. 3, the page collector 210, timer 220, and position determiner 230 support creation and management of a sub-list. When the user views a particular section of a webpage being displayed, for longer than or equal to a preset time duration, the page collector 210 generates or retrieves a sub-list on the basis of the viewed section. The timer 220 unit includes means for checking whether a webpage remains displayed without change for a preset time duration, and measures the presentation duration for a webpage.

When the user connects to a webpage and navigates the webpage through the left and right keys or the slide key, the page collector 210 sets the timer 220 to a given time value and finds a section of the webpage on which the pointing box stays for longer than or equal to the time duration set in the timer 220. When a section of the webpage on which the pointing box stays for longer than or equal to the time duration is found, the page collector 210 controls the position determiner 230 to obtain information regarding the position of the section on the webpage. The page collector 210 may create a sub-list entry containing the timer information and position information and insert the sub-list entry to the sub-list associated with the webpage list containing the current webpage. This procedure may be repeated until the current webpage is deactivated owing to webpage closing or activation of another webpage by the user.

Creation and management of a webpage list and sub-list are described with reference to the drawings.

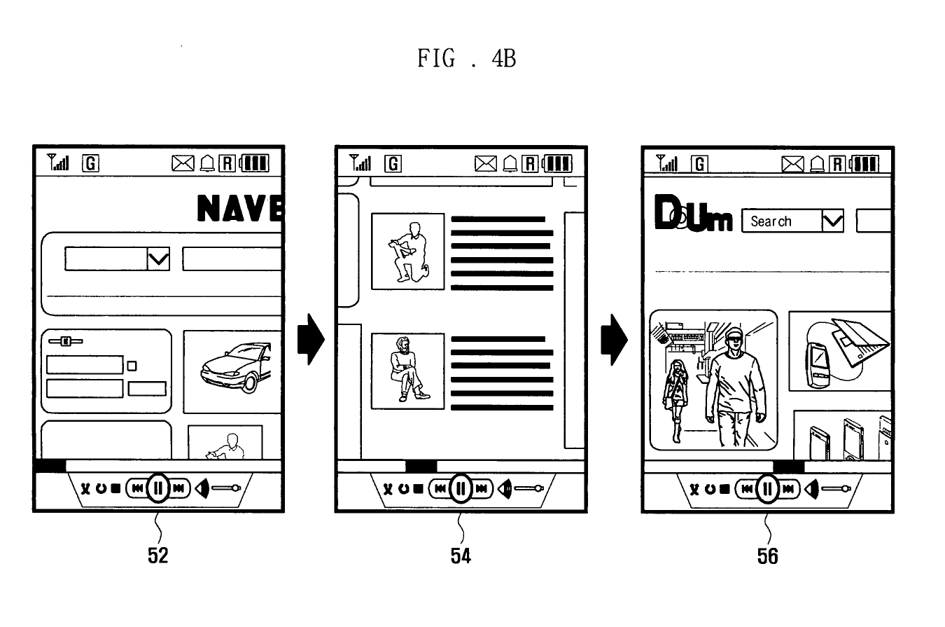

FIG. 4 illustrates screen representations for lists and sub-lists.

Referring now to FIG. 4, the mobile terminal activates a web browser, connects to a web server, downloads a webpage from the server, and displays the whole webpage on the display unit as shown by a screen 51. When the current webpage is an initial webpage, or is unrelated to the previous webpage, the history management module may create a webpage list containing the current webpage as an entry. The webpage list may be named after, for example, the address or logo of the current webpage (for example, ‘NAVER’). The mobile terminal provides a pointing box 510 to enable the user to browse a particular section of a webpage, and the pointing box is movable along the webpage in response to input of a directional key or a slide key, etcetera. In addition, in the case of a touch screen, the user may be able to move the pointing box along the screen in a desired direction with a finger or stylus.

FIG. 4 shows that the screen 51 has the pointing box 510 placed on the top left section of the webpage. When a signal for detailed view (for example, staying of the pointing box for a preset time duration or a key input signal from the input unit) is received, the mobile terminal enlarges the top left section as shown by screen 52. The screen 52 illustrates a login area, a search box area, a portion of an advertisement area, and a link area in more detail. The screen 52 typically includes hyperlinks to text information or image information that could be links to other web pages on the same web site, or web pages located on another web site. When the user selects and activates a particular link, the mobile terminal may generate a webpage related to the selected link.

When the user enters a direction key in the screen 51, the pointing box 510 moves to a central section of the webpage as shown by screen 53. When the user inputs a key input signal for detailed view or the pointing box 510 stays at the central section for a preset time duration, the mobile terminal enlarges the central section as shown by screen 54. The screen 54 may illustrate image link information and text link information at the enlarged central section in greater detail.

The history management module activates the timer when the screen 52 or screen 54 is displayed, and checks whether the screen 52 or screen 54 remains displayed for a preset time duration. When the screen 52 or screen 54 remains displayed for a preset time duration, the history management module collects information regarding the timer, webpage section, and position of the section on the webpage for the screen 52 or screen 54, and creates a sub-list for the screen 52 or screen 54. The history management module may attach the created sub-list to the existing webpage list. The sub-list may be named after or similar (matches a least a portion of certain predetermined criteria) to the name of the webpage list for intuitive understanding.

When the user enters an address of another website in the address box of the screen 51, the mobile terminal may display a new webpage on the display unit as shown by screen 55 (new current webpage). At this time, the page classifier of the history management module checks the level of association between the previous webpage and the current webpage. If the association level is low, the page classifier may control an operation to create a new webpage list (named ‘Daum’ for example) for the current webpage. The display unit displays the whole webpage as shown by the screen 55, and provides a pointing box 510 to enable the user to browse a particular section of the webpage. In the screen 55, the pointing box 510 is placed on the top left section of the webpage. When a signal for detailed view (for example, staying of the pointing box 510 for a preset time duration or a key input signal from the input unit) is received, the mobile terminal enlarges the section indicated by the pointing box as shown by screen 56. The screen 56 illustrates a main logo area, a login area, a search box area, and a portion of an advertisement area in more detail. When the section indicated by the pointing box 510 is enlarged and displayed, the history management module activates the timer. When the screen 56 remains displayed for a preset time duration, the history management module collects information regarding the timer, webpage section, and position of the section on the webpage for the screen 56, and creates a sub-list using the collected information. The history management module may attach the created sub-list to the new webpage list.

When the user performs a history search after webpage browsing, the history management module may support list browsing or sub-list browsing. When the user requests list browsing, the history management module controls the display unit to output the screen 51 and the screen 55 in sequence as slides in this example. It is within the spirit and scope of the invention that both screens are displayed simultaneously, or might overlap each other for a predetermined period where the first screen is shown on top, followed by a period where the second screen is shown on top. In this current example shown in FIG. 4, when the user requests sub-list browsing for the ‘NAVER’ webpage list, the history management module controls the display unit to output the screen 52 and the screen 54 in sequence as slides. When the user requests sub-list browsing for the ‘NAVER’ webpage list, the history management module may control the display unit to output the screen 51 and the screen 53 in sequence as slides according to settings. During sub-list browsing, the mobile terminal may vary screen display durations of individual webpage sections on the basis of timer information. The mobile terminal may also support integrated list browsing. When the user requests integrated list browsing, the history management module may control the display unit to output the screen 51, screen 53, and screen 55 in sequence as slides, for example.

As described above, the webpage history handling apparatus according to an exemplary embodiment of the present invention groups webpages by association level and manages the grouped webpages using lists, and provides sub-lists for sections of webpages in the lists on the basis of browsing conditions. Hence, the webpage history handling apparatus enables adequate history management for visited webpages, and can provide intuitive and understandable history information for browsing visited webpages.

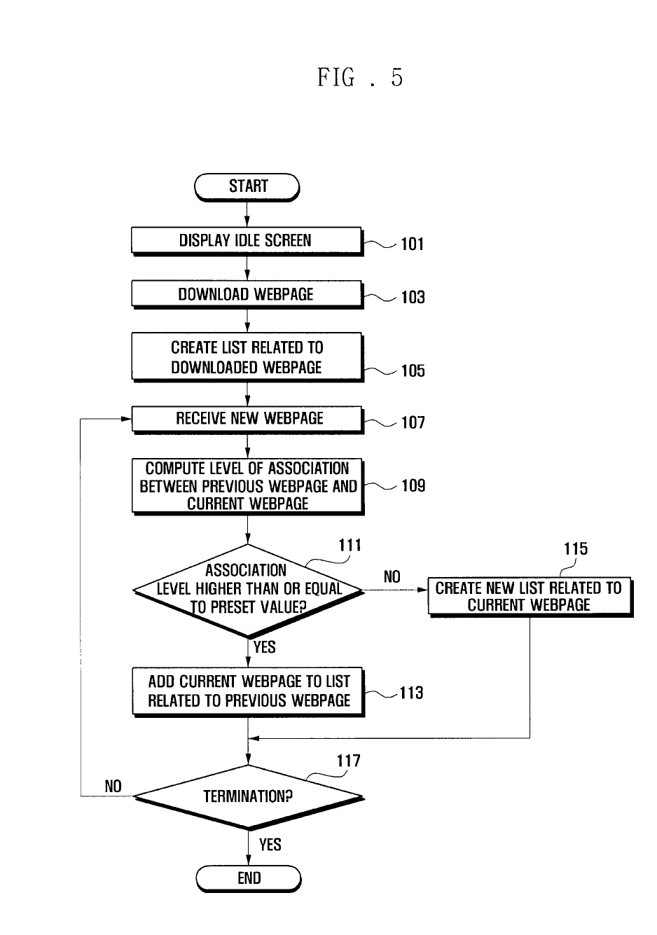

FIG. 5 is a flow chart illustrating exemplary operation of a history list generation procedure according to another exemplary embodiment of the present invention.

Referring now to FIG. 5, after powering on, the mobile terminal displays a preset idle screen on the display unit (101). A person of ordinary skill in the art understands and appreciates that the display of an idle screen is optional and not required to practice the claimed invention. In response to an input signal for web browsing from the input unit, the mobile terminal activates the web browser to connect to a web server using a preset web address or a web address input from the input unit and downloads a webpage (103). The mobile terminal then creates a webpage list containing the downloaded webpage (105). The webpage list may be named on the basis of the web address or the contents of the webpage.

When the user enters an input signal for another webpage, or activates a link on the current webpage, the mobile terminal receives a new webpage (107). The mobile terminal computes the level of association between the previous webpage and the current webpage (109). The level of association denotes the level of similarity between the previous webpage and the current webpage. For example, when the current webpage is generated by selecting a link in the previous webpage, by entering a web address similar (i.e. matches a least a portion of certain predetermined criteria) to that for the previous webpage, or by entering a search term similar (i.e. matches a least a portion of certain predetermined criteria) to that for the previous webpage, the mobile terminal may determine that the level of association between the previous webpage and the current webpage is comparatively high with a predetermined or threshold value.

In the case where the current webpage is generated by entering a search term different from that for the previous webpage, by entering a web address different from that for the previous webpage, or by selecting an advertisement link in the previous webpage, the mobile terminal may determine that the level of association between the previous webpage and the current webpage is comparatively low with a predetermined level or threshold value. To achieve this determination, the mobile terminal may assign weights to various cases. For example, to compare a search term for the previous webpage with that for the current webpage, the mobile terminal may assign different weights to the case where the two search terms are the same in whole and the case where the two search terms are the same in part. Similarly, the mobile terminal may assign different weights in the case where the two addresses of the previous and current webpages are the same in whole and the case where the two addresses are the same at least in part. The mobile terminal may also assign different weights in the case where the current webpage is generated by selecting an advertisement link in the previous webpage and the case where the current webpage is generated by selecting a non-advertisement link in the previous webpage.

The mobile terminal checks whether the computed association level is greater than or equal to a preset value (111). If the association level is greater than or equal to the preset value, the mobile terminal adds the current webpage as an entry to the webpage list containing the previous webpage (113).

However, if the association level is lower than the preset value, the mobile terminal creates a new webpage list containing the current webpage (115). The new webpage list may be named on the basis of the web address or logo of the current webpage.

The mobile terminal checks whether a request for terminating web browsing is issued (117). When a request for terminating web browsing is not issued, the mobile terminal returns to step 107 for continued processing.

As described herein above, the history list generation procedure checks the level of association between the previous webpage and the current webpage, adds the current webpage to the webpage list containing the previous webpage if the association level is comparatively high, and creates a new webpage list containing the current webpage if the association level is comparatively low.

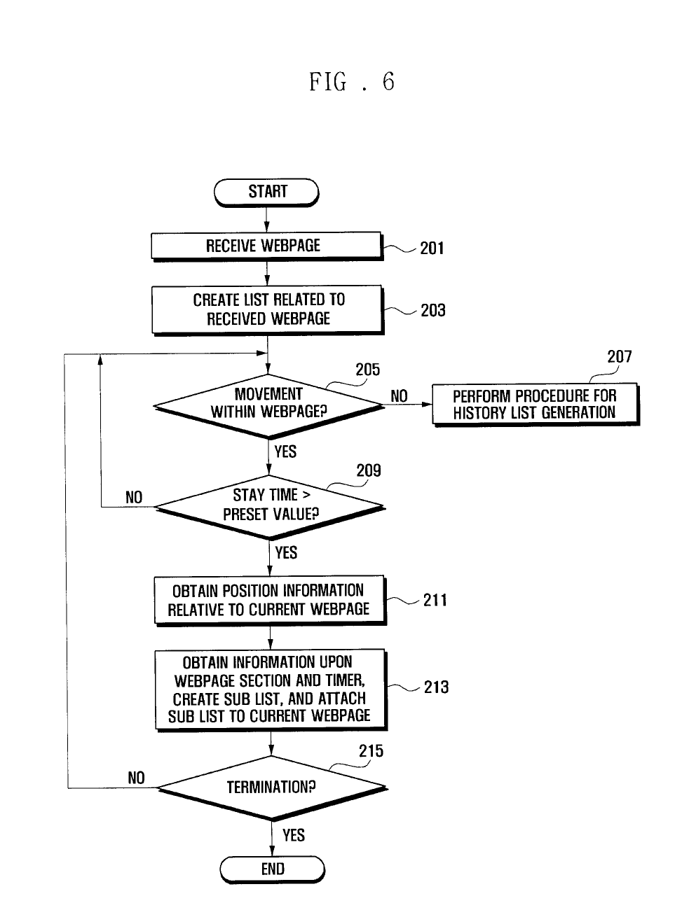

FIG. 6 is a flow chart illustrating an exemplary operational procedure for sub history list generation according to another exemplary embodiment of the present invention.

Referring now to FIG. 6, in response to an input signal for web browsing from the input unit, the mobile terminal activates the web browser to connect to a web server using a preset web address or a web address input from the input unit and receives a webpage (201). The mobile terminal may create a webpage list on the basis of the received webpage (203). At step 203, the mobile terminal may check the level of association between the previous webpage and the current webpage, and add the current webpage as an entry to the webpage list containing the previous webpage depending upon the checking result.

The mobile terminal checks whether an input signal from the input unit is a request for internal webpage browsing (not webpage generation) (205). That is, the mobile terminal may check whether a direction key signal (or touchscreen indication) is an input for moving the pointing box on the current webpage. If the input signal is a request for webpage generation (not browsing), the mobile terminal may perform the procedure for history list generation according to webpage generation (207). Step 207 is related to the procedure described in connection with FIG. 5, and is not described further.

If the input signal is a request for internal webpage browsing, the mobile terminal checks whether the pointing box for webpage viewing does not move for longer than or equal to a preset time duration (209). If the pointing box moves before the preset time duration expires, the mobile terminal returns to step 205 for checking the next input signal. In some cases, the mobile terminal may directly proceed to step 209 (checking the dwell time of the pointing box) without performing step 205 (checking internal webpage browsing).

If the pointing box does not move for an amount of time longer than or equal to the preset time duration, the mobile terminal obtains position information of the webpage section indicated by the pointing box with respect to the current webpage (211). The mobile terminal obtains information regarding the webpage section and the timer, creates a sub-list containing the obtained information, and attaches the created sub-list to the current webpage (213).

The mobile terminal checks whether a request for terminating web browsing is issued (215). When a request for terminating web browsing is not issued, the mobile terminal returns to step 205 for continued processing.

As described herein above, for more detailed viewing of a webpage, the procedure for sub-list generation supports generation of a history list for sections in the webpage.

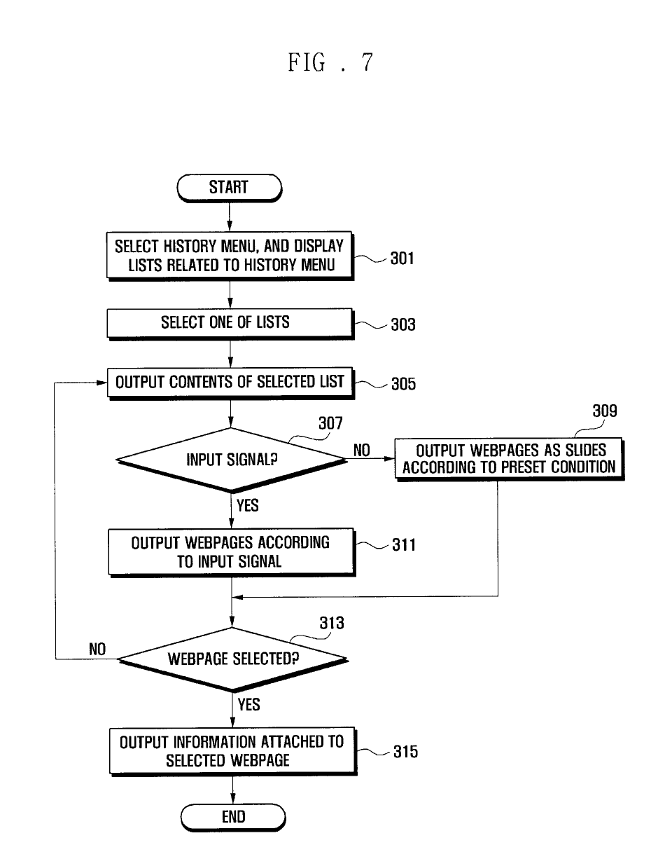

FIG. 7 is a flow chart illustrating an exemplary operation of procedure for history list browsing according to another exemplary embodiment of the present invention.

Referring now to FIG. 7, when the user selects a history menu, the mobile terminal displays webpage lists related to the selected history menu (301). Each webpage list contains visited webpages that are closely associated.

The mobile terminal selects one of the webpage lists according to an input signal from the input unit (303). The mobile terminal outputs contents of the selected webpage list (305). That is, the mobile terminal may output webpages in the selected webpage list. Thereafter, the mobile terminal may output the contents according to a preset condition or an input signal. The mobile terminal checks whether an input signal is received (307). If an input signal is not received, the mobile terminal may output webpages as slides according to a preset condition (for example, at preset intervals) (309). If an input signal (for example, a direction key signal or touchscreen indication) is received, the mobile terminal outputs webpages according to the input signal (311). For example, when it is assumed that a webpage list contains five webpages and the first webpage is being output, the mobile terminal may output the second webpage or fifth webpage according to an input direction key signal.

The mobile terminal checks whether a webpage is selected during output of the contents (313). If a webpage is selected, the mobile terminal outputs information attached to the selected webpage (315). At step 315, the mobile terminal may check whether the selected webpage has a sub-list. If the selected webpage has a sub-list, the mobile terminal may output the contents of the sub-list as slides. The mobile terminal may read webpage sections and their position information from the storage unit, and output the webpage sections through the display unit at preset intervals. The mobile terminal may further read presentation duration information and control the display duration of the webpage sections on the basis of the presentation durations. That is, one webpage section may be displayed for a time longer or shorter than another webpage section. For storage efficiency, the sub-list may contain position and time information as to a webpage section at which the pointing box had stayed for longer than or equal to a preset time duration.

As apparent from the above description, the webpage history handling method of the present invention manages highly associated webpages as a single list in an integrated manner, provides understandable information regarding webpages visited by the user, and enables the webpages to be easily revisited. In addition, the webpage history handling method manages sections of a webpage carefully viewed by the user as a sub-list, enabling fine tracking of webpage browsing.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims. It should also be understood that the appended claims are not limited to the examples shown and described herein.

What is claimed is:

1. A webpage history handling method for a mobile terminal, comprising:
receiving a first webpage from a connected web server;
creating a list related to the first webpage;
receiving a second webpage;
examining a level of association between the second webpage and first webpage; and
performing webpage grouping by adding, when the association level compares favorably with a preset value, the second webpage to the list related to the first webpage, and by creating, when the association level does not compare favorably with the preset value, a list related to the second webpage.

2. The webpage history handling method of claim 1, further comprising:
measuring a dwell time of a pointing box at a section of the current webpage displayed on a display unit;
collecting, when the dwell time is longer than or equal to a preset time value, position information of the webpage section indicated by the pointing box relative to the current webpage in its entirety; and
creating a sub-list on the basis of the position information of the webpage section.

3. The webpage history handling method of claim 2, further comprising attaching the created sub-list to the current webpage.

4. The webpage history handling method of claim 3, further comprising:
selecting a history menu;
outputting one or more webpage lists mapped to the history menu; and
outputting information as to webpages contained in a selected one of the one or more webpage lists.

5. The webpage history handling method of claim 4, further comprising:
outputting, when a directional signal is received, webpages in the selected list according to the directional signal;
selecting one of the webpages in the selected list; and
outputting, when the selected webpage has an attached sub-list, information contained in the sub-list.

6. The webpage history handling method of claim 5, wherein outputting information contained in the sub-list comprises outputting webpage sections indicated by the pointing box as slides in a manner that slide switching times are set according to dwell times of the pointing box at individual webpage sections.

7. The webpage history handling method of claim 1, wherein performing webpage grouping comprises:
adding, when the current webpage is generated in response to activation of a non-advertisement link of the previous webpage, the current webpage to the list related to the previous webpage; and
creating, when the current webpage is generated in response to activation of an advertisement link of the previous webpage, a new list related to the current webpage.

8. The webpage history handling method of claim 1, wherein performing webpage grouping comprises at least one of:
creating, when the current webpage is generated by selecting a bookmark, a new list related to the current webpage;
creating, when the current webpage is generated by entering a new web address in an address box, a new list related to the current webpage; and
creating, when the current webpage is generated by entering a new search term in a search box, a new list related to the current webpage.

9. The webpage history handling method of claim 1, wherein performing webpage grouping comprises adding, when the current webpage is generated by selecting a bookmark or by entering a new web address in an address box and the web address of the current webpage is matches a least a portion of certain predetermined criteria of that of the previous webpage, the current webpage to the list related to the previous webpage.

10. The webpage history handling method of claim 1, wherein performing webpage grouping comprises adding, when the current webpage is generated by entering a search term in a search box and the search term for the current webpage matches a least a portion of certain predetermined criteria of that for the previous webpage, the current webpage to the list related to the previous webpage.

11. A webpage history handling apparatus for a mobile terminal, comprising:
a radio frequency unit connecting to a web server and receiving webpage data from the web server;
a history management module creating a list related to an initially received webpage, examining, when the current webpage is generated, the level of association between the current webpage and previous webpage, adding, when the association level compares favorably with a preset value, the current webpage to the list related to the previous webpage, and creating, when the association level does not compare favorably with the preset value, a list related to the current webpage; and
a display unit outputting a webpage and a list of webpages.

12. The webpage history handling apparatus of claim 11, wherein the history management module comprises:
a timer measuring a dwell time of a pointing box at a section of an output webpage;
a position determiner collecting, when the measured dwell time is longer than or equal to a preset time value, position information of the webpage section indicated by the pointing box relative to the output webpage in whole; and
a page collector creating a sub-list on the basis of the position information of the webpage section.

13. The webpage history handling apparatus of claim 12, wherein the page collector attaches the created sub-list to the current webpage.

14. The webpage history handling apparatus of claim 13, wherein the display unit outputs a history menu, outputs webpage lists mapped to the history menu, and outputs information as to webpages contained in a selected one of the webpage lists.

15. The webpage history handling apparatus of claim 14, further comprising an input unit generating a direction key signal, and wherein the display unit outputs, when a directional signal is input, webpages in the selected list according to the directional signal.

16. The webpage history handling apparatus of claim 15, wherein the display unit outputs, when one of the webpages in the selected list is selected and the selected webpage has an attached sub-list, information contained in the sub-list.

17. The webpage history handling apparatus of claim 16, wherein the display unit outputs webpage sections indicated by the pointing box as slides having slide switching times that are set according to dwell times of the pointing box at the individual webpage sections.

18. The webpage history handling apparatus of claim 11, wherein the history management module adds, when the current webpage is generated by activation of a non-advertisement link of the previous webpage, the current webpage to the list related to the previous webpage, and creates, when the current webpage is generated by activation of an advertisement link of the previous webpage, a new list related to the current webpage.

19. The webpage history handling apparatus of claim 11, wherein the history management module creates a new list related to the current webpage when the current webpage is generated by one of selecting a bookmark, entering a new web address in an address box, and entering a new search term in a search box.

20. The webpage history handling apparatus of claim 11, wherein the history management module adds the current webpage to the list related to the previous webpage when the web address of the current webpage is matches a least a portion of certain predetermined criteria of that of the previous webpage or the search term causing the current webpage is matches a least a portion of certain predetermined criteria of that causing the previous webpage.
